(19) United States
(12) Patent Application Publication
(10) Pub. No.: US 2009/0285617 A1
(43) Pub. Date: Nov. 19, 2009

(54) Tape Printing Apparatus and Tape Cassette

(76) Inventor: Kris Vandermeulen, Bornem (BE)

Correspondence Address: MARSHALL, GERSTEIN & BORUN LLP, 233 SOUTH WACKER DRIVE, 6300 SEARS TOWER, CHICAGO, IL, 60606-6357, US

(21) Appl. No.: 12/375,015

(22) PCT Filed: Jul. 25, 2007
(86) PCT No.: PCT/IB07/03203

§ 371 Date: Jan. 23, 2009

(30) Foreign Application Priority Data
Jul. 26, 2006 (GB) 0614868.8

(51) Int. Cl. B41J 11/00

(52) U.S. Cl. 400/621

(57) ABSTRACT

A method of printing an image on an image receiving tape comprising advancing the tape in a first direction such that a predetermined portion of the tape is downstream of the printing location, printing an image while advancing the tape in a second direction cutting the tape when at least the predetermined portion of tape is downstream of the cutting location, and cutting the tape again when the end of the image is a predetermined distance upstream of the cutting location.

### FIELD OF INVENTION

The present invention relates to a tape printing apparatus, and to a method of printing on and cutting an image receiving tape to form a label. In particular, but not exclusively, the present invention relates to a tape printing apparatus for printing an image, such as a background image on an image receiving tape so that the image is printed across the length of the entire label.

### BACKGROUND OF THE INVENTION

Printers capable of printing background images include direct thermal printers. For example, EP 1638780 describes a method of printing a label in which a multicoloured image is produced on the tape by direct thermal transfer in a single pass of the tape past the print head, resulting in a high quality colour image.

When printing a colour background such as a single block colour, it is possible to print a background which covers the entire width of the label since the width of the print head exceeds the width of the tape. However, printing across the entire length of the label in a single pass is not currently possible due to the location of the cutter in relation to the location of the print head. FIG. 1 (a) shows the relative positions of the print head 60, the platen 80, the cutter 20 and the image receiving tape 40 in a tape printing apparatus (not shown) during printing. FIG. 1 (b) shows the position of the tape 40 at various stages of printing. As shown in FIGS. 1 (a) and (b) the print line 90 is at a distance x from the cutting line 100. Consequently, after a first label is cut from the tape, a distance x exists between the end of the tape and the beginning of the print line. Accordingly the label is printed with a blank leader of length x. Examples of labels printed in this manner are shown in FIG. 2.

Often a blank trailer of the same length is added to the label to give the label a symmetrical appearance. However a blank leader and trailer are usually not desirable, especially when labels are printed with a background therefore making the blank regions noticeable.

Embodiments of the present invention aim to address at least one of the above-mentioned problems.

### SUMMARY OF THE INVENTION

According to a first aspect of the present invention, there is provided a method of printing an image on an image receiving tape comprising advancing the tape in a first direction such that a predetermined portion of the tape is downstream of the printing location, printing an image while advancing the tape in a second direction, cutting the tape when at least the predetermined portion of tape is downstream of the cutting location, and cutting the tape again when the end of the image is a predetermined distance upstream of the cutting location.

According to a second aspect of the present invention there is provided a method of printing an image on an image receiving tape comprising cutting the image receiving tape at a first and second cutting location to remove a previous label, advancing the image receiving tape in a first direction such that the position of the first cut on the image receiving tape is a predetermined distance upstream of a printing location, printing the image, advancing the image receiving tape in a second direction to a position where the end of the image is between the first and second cutting locations and cutting the image receiving tape at said first and second cutting locations.

According to a third aspect of the present invention there is provided a method of printing an image on an image receiving tape comprising advancing the tape in a first direction such that the end of the tape is at a printing location, printing the image, advancing the tape in a second direction to a position where the end of the image is a predetermined position from a cutting location, and cutting the tape to form a label.

According to a fourth aspect of the present invention there is provided a method of printing an image on an image receiving tape comprising advancing the tape in a first direction such that the end of the tape is at a printing location, printing a first part of the image while advancing the tape in the first direction, cutting the tape when the end of the label is at a cutting location and printing a second part of the image while advancing the label in the first direction.

According to a fifth aspect of the present invention there is provided a method of printing a label on an image receiving tape, said method comprising cutting a partial cut in the tape at a first cutting location, advancing the tape in a first direction to a position where the end of the tape is located at a printing location, printing the image on the tape whilst advancing the tape in the first direction, and cutting a full cut in the tape at a second cutting location during printing.

According to a sixth aspect of the present invention there is provided a method of printing an image on an image receiving tape comprising advancing the tape in a first direction such that the end of the image receiving tape is a predetermined distance upstream of the printing location, printing on the tape while advancing the tape in a second direction and cutting the image receiving tape at a cutting location to form a label.

According to a seventh aspect of the present invention there is provided a tape printer comprising a cassette receiving portion for receiving a cassette, a print head comprising a plurality of printing elements for printing an image on a tape, a drive means for driving a tape passed the print head, a cutter arranged to cut the tape at a cutting location and a control means for controlling the drive means to advance the tape in a first direction such that a predetermined portion of the tape is downstream of a printing location before printing, and for controlling the cutter to cut the tape when at least the predetermined portion of tape is downstream of the cutting location, and wherein the control means is arranged to control the cutter to cut the tape again when the end of the image is a predetermined distance upstream of the cutting location.

According to an eighth aspect of the present invention there is provided a tape printer comprising a cassette receiving portion for receiving a cassette, a print head comprising a plurality of printing elements for printing an image on an image receiving tape, a drive means for driving the image receiving tape passed the print head, a control means for controlling: a cutter to cut the tape at a first and second cutting location to remove a previous label, the drive means to advance the tape in a first direction such that the position of the first cut on the image receiving tape is a predetermined distance upstream of a printing location before printing, and to advance the tape in a second direction to a position where the end of the printed image is between the first and second cutting location and further controlling the cutter to cut the tape at the first and second cutting locations.

According to a ninth aspect of the present invention there is provided a tape printer comprising; a cassette receiving portion for receiving a cassette, a print head comprising a plurality of printing elements for printing an image on a tape, a drive means for driving a tape passed the print head, a control means for controlling the drive means to advance the tape in a first direction such that the end of the tape is at a printing location before printing, and to advance the tape in a second direction to a position where the end of the printed image is a predetermined position from a cutting location; and a cutter arranged to cut the tape at the cutting location to form a label.

According to a tenth aspect of the present invention there is provided a tape printer comprising; a cassette receiving portion for receiving a cassette, a print head comprising a plurality of printing elements for printing an image on a tape, a drive means for driving a tape passed the print head, a tab cutter arranged to cut a partial cut in the tape at a first cutting location a control means for controlling the drive means to advance the tape in a first direction before printing, to a position where the end of the tape is located at a printing location, and to advance the tape in the first direction during printing; and a cutter arranged to cut a full cut in the tape at a second cutting location during printing.

According to an eleventh aspect of the present invention there is provided a tape printer comprising; a cassette receiving portion for receiving a cassette, a print head comprising a plurality of printing elements for printing an image on a tape, a drive means for driving a tape passed the print head, a control means for controlling the drive means to advance the tape in a first direction such that the end of the tape is a predetermined distance upstream of a printing location before printing before printing, and to advance the tape in a second direction during printing; and a cutter arranged to cut the tape at a cuffing location to form a label.

### BRIEF DESCRIPTION OF DRAWINGS

For a better understanding of the present invention and as to how the same may be carried into effect, embodiments of the present invention will now be described with reference to the following drawings:

FIG. 1(a) shows the relative positions of the print head, cutter and image receiving tape during printing according to the prior art.

FIG. 1(b) shows the image receiving tape at various stages of printing, according to the prior art;

FIG. 2 shows examples of labels produced with blank leaders according to the prior art;

FIG. 3 shows a schematic diagram of a tape printing apparatus according to an embodiment of the present invention;

FIG. 4 shows schematically control circuitry for controlling a tape printing device embodying the present invention;

FIG. 5 shows a schematic cross sectional view of a tape printer according to an embodiment of the present invention;

FIG. 6 shows a schematic cross sectional view of a tape printer according to a further embodiment of the present invention;

FIG. 7 shows the image receiving tape at various stages of printing, according to an embodiment of the present invention;

FIG. 8 shows examples of labels produced with blank leaders according to the embodiment of the invention as described in relation to FIG. 7;

FIG. 9 shows the image receiving tape at various stages of printing, according to another embodiment of the present invention;

FIG. 10 shows examples of labels produced without blank leaders according to other embodiments of the present invention;

FIG. 11 shows the image receiving tape at various stages of printing, according to another embodiment of the present invention;

FIG. 12 shows the image receiving tape at various stages of printing, according to another embodiment of the present invention;

FIG. 13 shows the image receiving tape at various stages of printing, according to another embodiment of the present invention;

FIG. 14 shows the image receiving tape at various stages of printing, according to another embodiment of the present invention;

FIG. 15 shows a schematic cross sectional view of a tape printer according to another embodiment of the present invention;

FIG. 16 shows a tape supply used in accordance with the present invention;

FIG. 17 shows the image receiving tape at various stages of printing, according to another embodiment of the present invention;

FIG. 18 shows the image receiving tape at various stages of printing, according to another embodiment of the present invention;

FIG. 19 shows the image receiving tape at various stages of printing, according to another embodiment of the present invention;

FIG. 20 shows the image receiving tape at various stages of printing, according to another embodiment of the present invention.

### DETAILED DESCRIPTION OF INVENTION

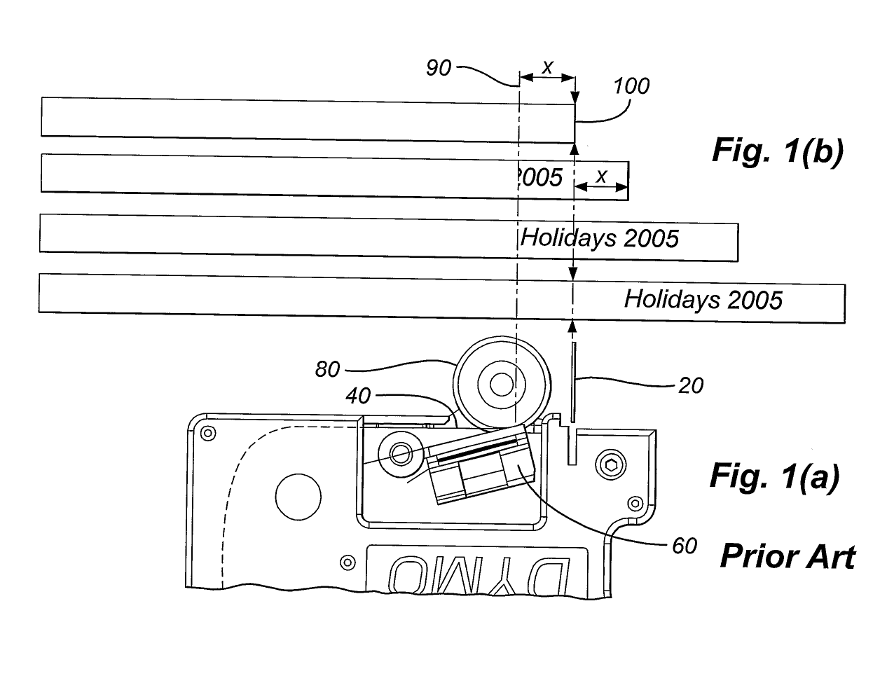

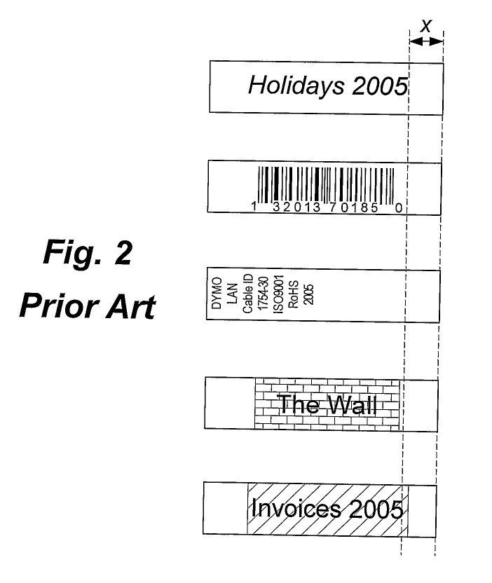

FIGS. 1 to 2 indicate prior art and have already been discussed in the preamble of this specification.

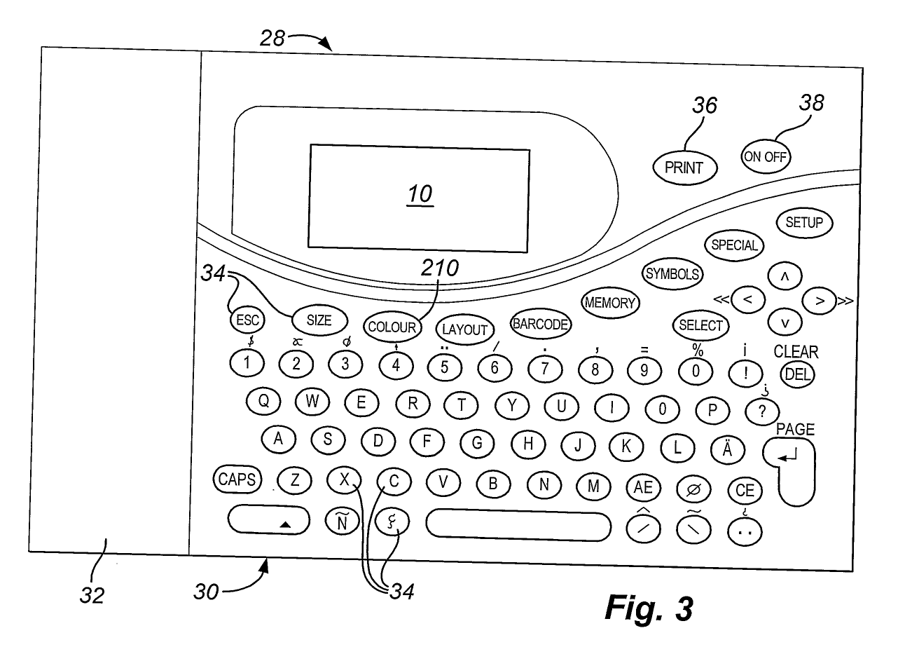

FIG. 3 shows a schematic diagram of a tape printing apparatus 28 according to an embodiment of the present invention. The tape printing apparatus comprises a keyboard 30 and a cassette receiving bay 32. The keyboard has a plurality of data entry keys 34 such as numbered, lettered and punctuation keys for inputting data to be printed as a label and function keys for editing the input data. The keyboard may also have a print key 36 which is operated when it is desired that a label be printed. Additionally an on/off key 38 is also provided for switching the tape printing apparatus on and off.

The tape printing apparatus has a liquid crystal display (LCD) 10 which displays the data as it is entered. The display allows the user to view all or part of the label to be printed which facilitates the editing of the label prior to its printing. Additionally, the display is driven by a display driver (not shown).

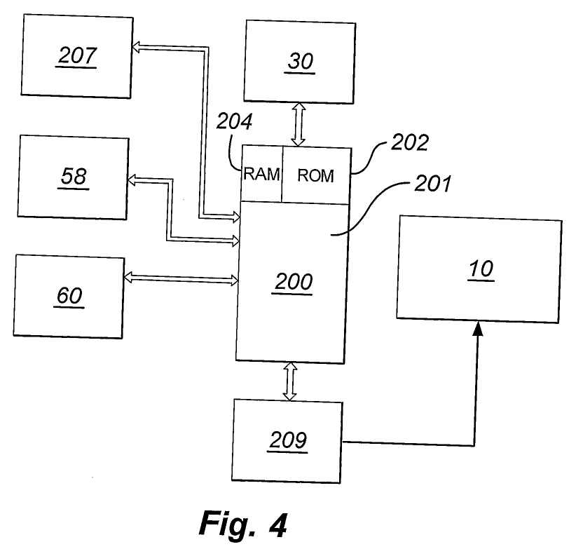

Basic circuitry for controlling the tape printing device 28 is shown in FIG. 4. There is a microprocessor chip 200 having a read only memory (ROM) 202, a microprocessor 201 and random access memory capacity indicated diagrammatically by RAM 204. The microprocessor chip 200 is connected to receive label data input to it from a data input device such as a keyboard 30. The microprocessor chip 200 outputs data to drive a display 10 via a display driver chip 209 to display a label to be printed (or a part thereof) and/or a message for the user. The display driver alternatively may form part of the microprocessor chip. Additionally, the microprocessor chip 200 also outputs data to drive the print head 60 so that the label data is printed onto the image receiving tape to form a label. The microprocessor chip 200 also controls the motor 207 for driving the platen. Finally the microprocessor chip 200 also controls the cutting mechanism 58 to allow a length of tape to be cut off. In some embodiments of the invention the cutter may be operated manually. Manual cutting operations may be disabled during printing. In a preferred embodiment of the invention, cutting operations performed during printing are controlled by the microprocessor 200.

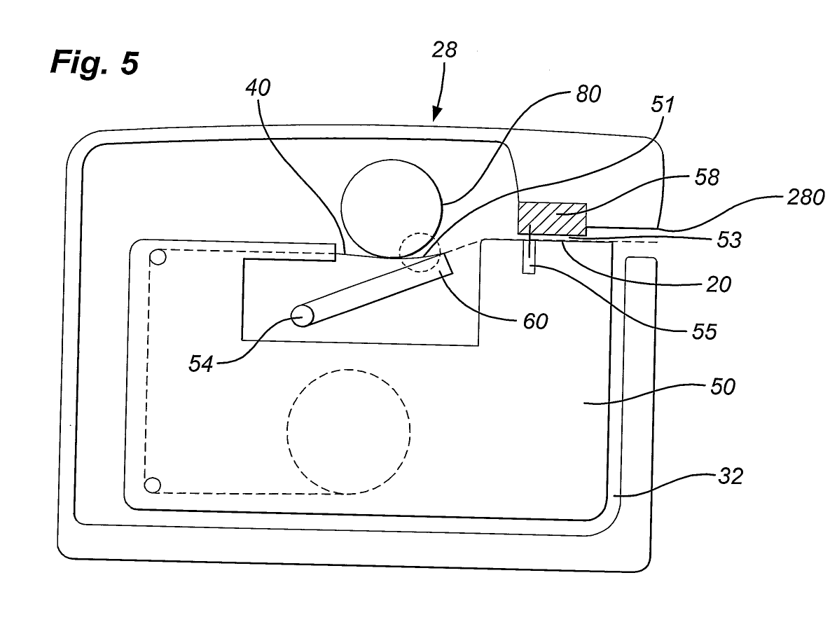

Reference is made to FIG. 5 which shows in plan view a tape printing device 28 according to an embodiment of the present invention which has a cassette 50 arranged therein. This cassette can contain a supply of colour direct thermal material. The cassette 50 is located in a cassette bay 32. The cassette bay 32 also accommodates at least one thermal print head 60 and a platen 80 which cooperate to define a print zone 51. Other arrangements for the printing are describe in more detail hereinafter. The print head 60 is able to pivot about a pivot point 54 so that it can be brought into contact with the platen 80 for printing and moved away from the platen 80 to enable the cassette 50 to be removed and replaced. In the operative position, the platen 80 is rotated to cause the image receiving tape 40 to be driven past the print head 60.

The platen 80 is driven by a DC motor (see FIG. 4) so that it rotates to drive the image receiving tape 40 through the print zone 51 of the tape printing device 28 during printing. According to another embodiment of the invention a stepper motor may be used to drive the platen. In this way, an image is printed on the tape and fed out from the printer by the tape exit 280.

The image is printed by the print head 60 on the thermally sensitive image receiving tape 40 on a line by line basis with the lines, otherwise referred to as columns, being adjacent one another in the direction of movement of the tape 40. Pixels are selectively activated in each column to construct an image in a manner well known in the art. The DC motor is provided with a shaft encoder for monitoring the speed of rotation of the motor. The control of the speed of the motor is achieved by the microprocessor chip 200 (see FIG. 4) to generate data strobe signals each of which causes a column of pixel data to be printed by the print head 60.

The tape printing device includes at cutting location 53 a cutting mechanism 58 which carries a blade 20. The blade 20 cuts the image receiving tape 40 then enters a slot 55 located in the cassette 50. The blade may be arranged to provide a full cut which extends through all the layers of the tape and a partial cut which only extends through the image receiving layer of the tape, otherwise referred to as a ‘tab’ cut.

Mechanisms for providing partial and full cuts are known and in this regard reference is made to our earlier patents EP 578372, EP 711670, EP 607027 and EP 711637, which are hereby incorporated by reference.

It is understood that other embodiments of the tape printer may be envisaged. For example, the tape printer of the present invention may be a PC printer rather than a stand-alone printer. In such a printer, a keyboard and display means are not essential as the data may be input and displayed on the PC. The PC then acts as an input device for the printer. Alternatively, other apparatus may be used to input data to the printer for printing. For example, in an embodiment of the invention a digital camera may be used to input data to the tape printing device for printing. Images may alternatively be input using a smart card, chip card, memory card or the like.

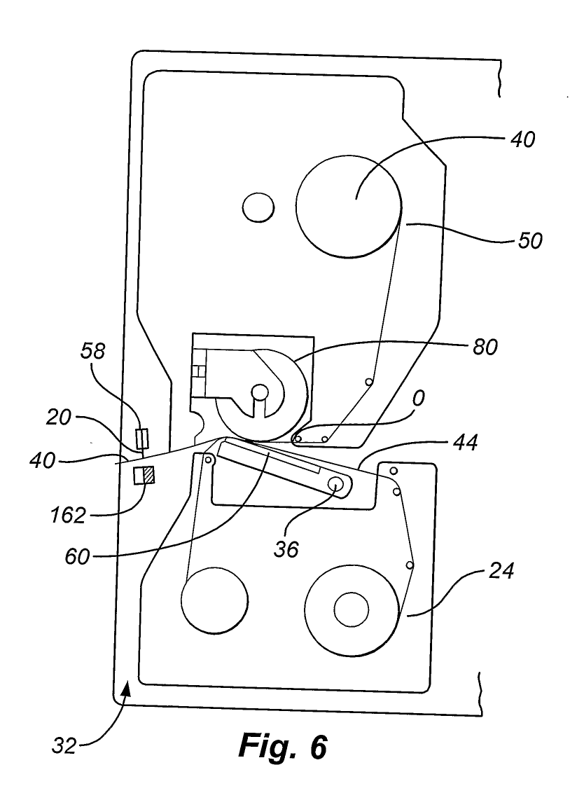

Tape printers embodying the present invention can also be arranged to do thermal transfer printing, that is using an ink ribbon. FIG. 6 shows a schematic diagram of a cassette receiving bay 32 in the tape printing apparatus when arranged to do thermal transfer printing. In this embodiment an ink ribbon cassette 24 is installed together with the image receiving tape cassette 50. The ink ribbon 44 passes through the print zone together with the image receiving tape.

In an alternative embodiment of the invention the image receiving tape and the ink ribbon may be provided in the same cassette.

In some embodiments of the present invention, the tape printer may be connected to a PC. In those embodiments, the tape printer may not have a keyboard or display. However, in some embodiments the tape printer will additionally have the display and keyboard. In the embodiments where the tape printer is connected to a PC, relatively complicated colour images can be downloaded from the PC to the tape printer for printing. These can be full colour images.

In one embodiment of the invention the user can select the both a background pattern and background colour for the image to be printed on the tape. Using one of the function keys, the user is able to access a background menu which lists the various options for the background. By way of example, the user can have no background, a patterned background, a plain background (i.e. a particular colour), an image background or a text background. Using a cursor, the user is able to select one of these options. The user may also be able to select a colour for the text. In embodiments of the invention the image may either include or not include a background.

In another embodiment of the present invention, the display may be a colour display and when the user inputs text, the text will have the selected colour on the display. Likewise, the background of the display will also have the required colour.

It should be emphasised that embodiments of the invention are not limited to the examples of the tape materials given in this application. Embodiments of the present invention can be used with fall colour direct thermal materials, with direct thermal materials which give a selection of two or more possible colours or printing onto the tape by transferring ink from an ink ribbon. When printing in monochrome, as may be the case when printing with an ink ribbon, a background image may be provided as a shaded image.

It should further be emphasised that embodiments of the invention are not limited to the thermal printing technology. Embodiments of the present invention can use inkjet print technology, laser print technology or any other technology to produce an image on an image receiving layer. In one of the embodiments of the present invention the print head may be an inkjet line print head which prints over the entire width of the tape without a translation movement in the direction perpendicular to the printing direction.

Preferred embodiments of the present invention are arranged so that information is automatically provided to or detected by the tape printer about the capabilities of the material. In other words whether the material is full colour, a thermal transfer material, a direct thermal material only providing one colour or a colour direct thermal material providing two or more colour options and if so what those colour options are. This information can be provided in a number of different ways. For example, the tape supply and/or cassette may have an element which provides the necessary information. In alternative embodiments of the present invention, the user may be able to set this from the keyboard. In other words, the user will provide the tape printer with information as to the type of tape material so that the tape printer can be controlled accordingly. In a further alternative embodiment of the invention the printer may be adapted to operate with only one type of image receiving tape, or in the same way regardless of the nature of the image receiving tape. In this case no detection means are necessary.

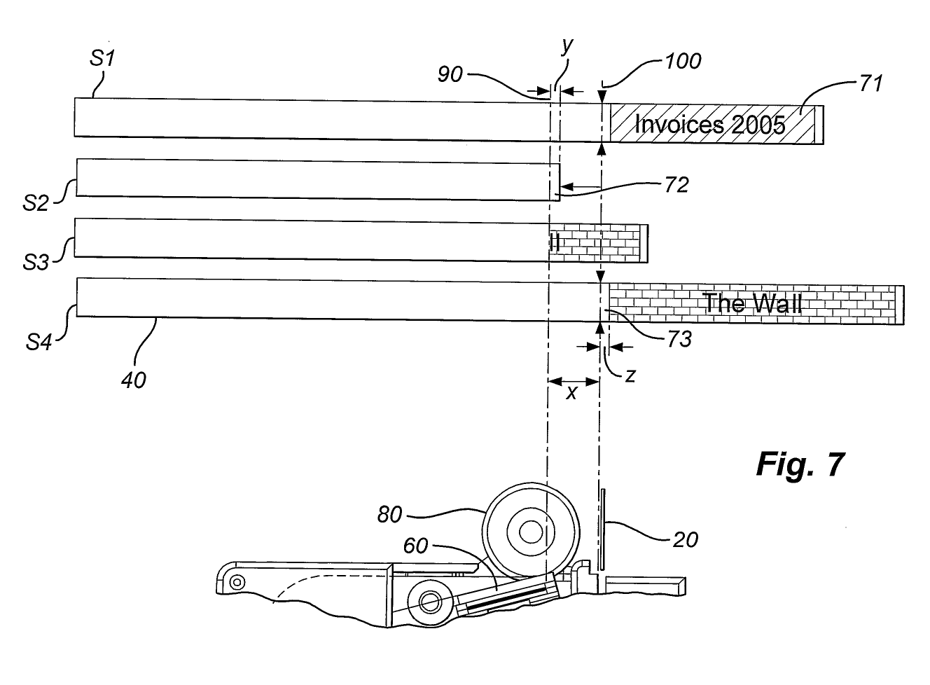

Reference is now made to FIG. 7 which shows the relative positions of the print head 60, the platen 80 and the cutter 20 of a tape printer 28, together with the corresponding positions of the image receiving tape 44 at various steps of printing, according to an embodiment of the present invention. The print line 90 indicates the position where printing occurs. As shown, the print line 90 is at a distance x from the cutting line 100.

At step one (S1), the preceding label 71 is cut from the image receiving tape supply 40 by cutter 20 making a full cut at a position indicated by line 100.

At step two (S2), the image receiving tape is reversed in an opposite direction to the direction in which the tape is fed during printing. This may be achieved for example by driving the platen 80 to rotate in the reverse direction with motor 207 (FIG. 4). In an alternative embodiment the tape is reversed by rotating the supply spool in the reverse direction, again with the motor 207. In a further alternative embodiment the tape may be reversed by driving the both platen and the supply spool in the reverse direction either dependently or independently. When only a small amount of tape is rewound, for example a length that is less than the distance between the supply pool and the print head, the tape may be reversed by the platen. Conversely if it is necessary to reverse the tape by a relatively large amount, for example a length that is greater than the distance between the supply spool and the print head, the tape may be reversed by rotating the supply spool in the reverse direction. The microprocessor controls the motor 207 to reverse the tape a distance x-y, where y is the length of tape which must be downstream of the print line 90 in order for the platen to be able to advance the tape.

At step three (S3), the image is printed on the image receiving tape. In one embodiment of the invention the image may include a background image. In another embodiment of the invention the image does not include a background image.

At step four (S4), the image receiving tape 40 is advanced by the rotation of the platen 80 such that the image on the tape is driven a distance z past the cutting line 100. The cutter 20 then makes a full cut to separate the label from the tape supply. In a preferred embodiment of the invention the distance z is set to be an equal distance to y to give a balanced appearance to the label, however z may be set at any value, including zero.

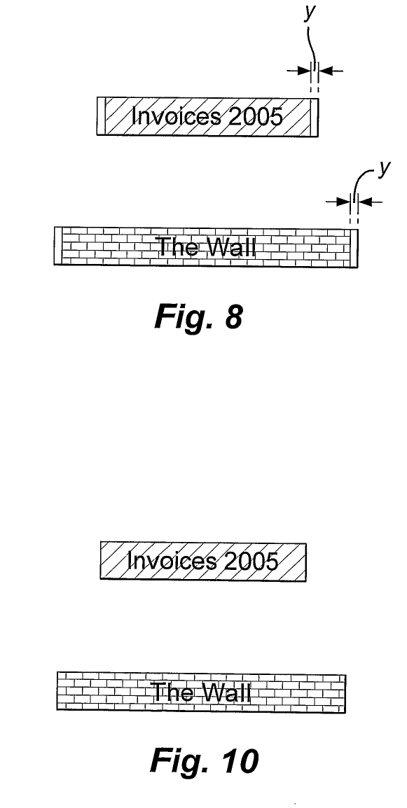

According to the steps set out above it is possible to reduce the length of the leader 72 to a length y, thereby improving the appearance of the label considerably. An example of labels produced in accordance with the embodiment of the invention as described in relation to FIG. 7 is shown in FIG. 8.

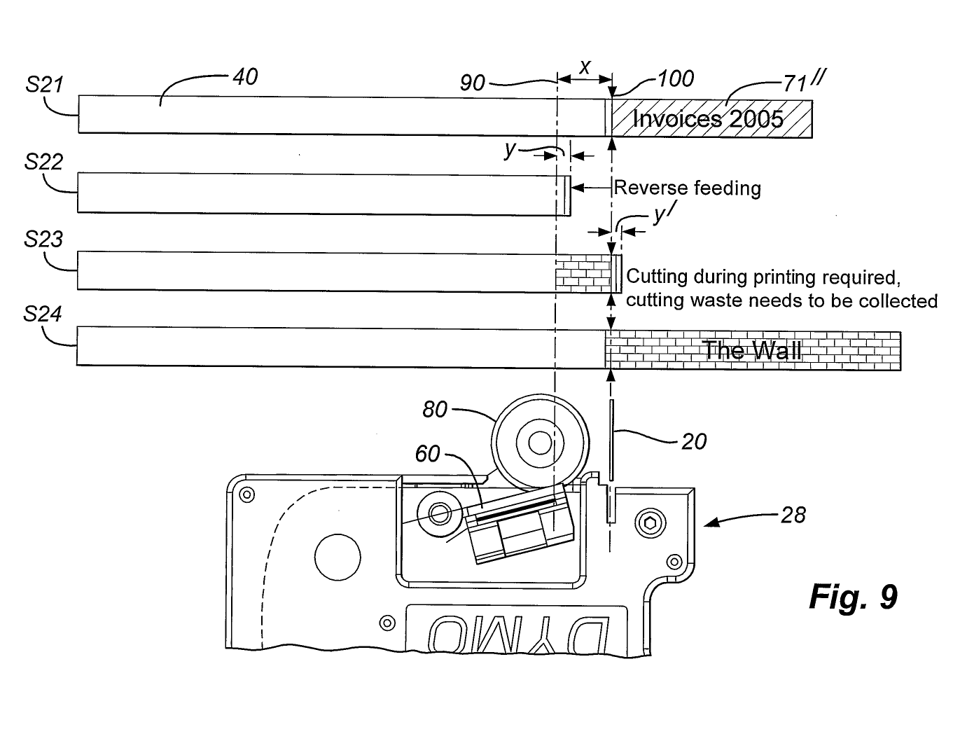

Reference is now made to FIG. 9 which again shows the relative positions of the print head 60, the platen 80 and the cutter 20 of a tape printer 28, together with the corresponding positions of the image receiving tape 40 at various steps of printing, according to another embodiment of the present invention. Again, the print line 90 indicates the position where printing occurs. As shown, the print line 90 is at a distance x from the cutting line 100.

At step S21, the preceding label 71″ is cut from the image receiving tape supply 40 by cutter 20 making a full cut at a position indicated by line 100. The full cut is made down stream of the last printed line of the image, i.e. before the end of the printed image. Since it is difficult to accurately cut the tape at the last printed line, cutting the tape within the image ensures that there is no unprinted tape at the end of label 71″.

At step S22, the image receiving tape is reversed. The microprocessor controls the motor 207 to reverse the tape a distance x-y, where y is the length of tape which must be downstream of the print line 90 in order for the platen to be able to advance the tape.

At step S23, the printer commences to print the image on the image receiving tape. When the leading edge of image receiving tape travels a distance y′ past the cutting line 100, printing is momentarily suspended and the cutter 20 makes a full cut thereby removing the leading trailer from the tape. The distance y′ may be greater than or equal to y. In a preferred embodiment y′ is set to be greater than y to ensure that there is no unprinted portion left at the leading edge of the tape. The cut off section is allowed to fall into a waste box (not shown) provided in the printer beneath the location of the cutter. Printing is then resumed.

At step 24, once the image has been printed on the image receiving tape, the tape is advanced by to a position such that a small portion of the printed image, or at least the last printed line of the image on the tape is upstream of the cutting line 100. The tape may be advanced by the rotation of the platen, or any other mechanism known in the art suitable for advancing the tape. The cutter 20 then makes a full cut to separate the label from the tape supply.

According to the steps set out above it is possible to print a label without blank trailers or leaders, thereby significantly improving the appearance of the label. An example of labels produced in accordance with the embodiment of the invention as described in relation to FIG. 9 is shown in FIG. 10.

In an alternative embodiment of the invention, the cutter is arranged to perform a partial cut at step S23 in FIG. 9. Both the full cut at steps S21 and S24, and the partial cut at step S23 may be executed by the same cutting mechanism. By performing a partial cut at step S23, there is no cutting waste which needs to be collected. Instead, according to this embodiment of the invention the waste part of the tape of length y′ stays on the liner. When the label is removed from the liner by the user, a label without blank trailers is produced. Examples of labels without blank leaders or trailers are shown in FIG. 10.

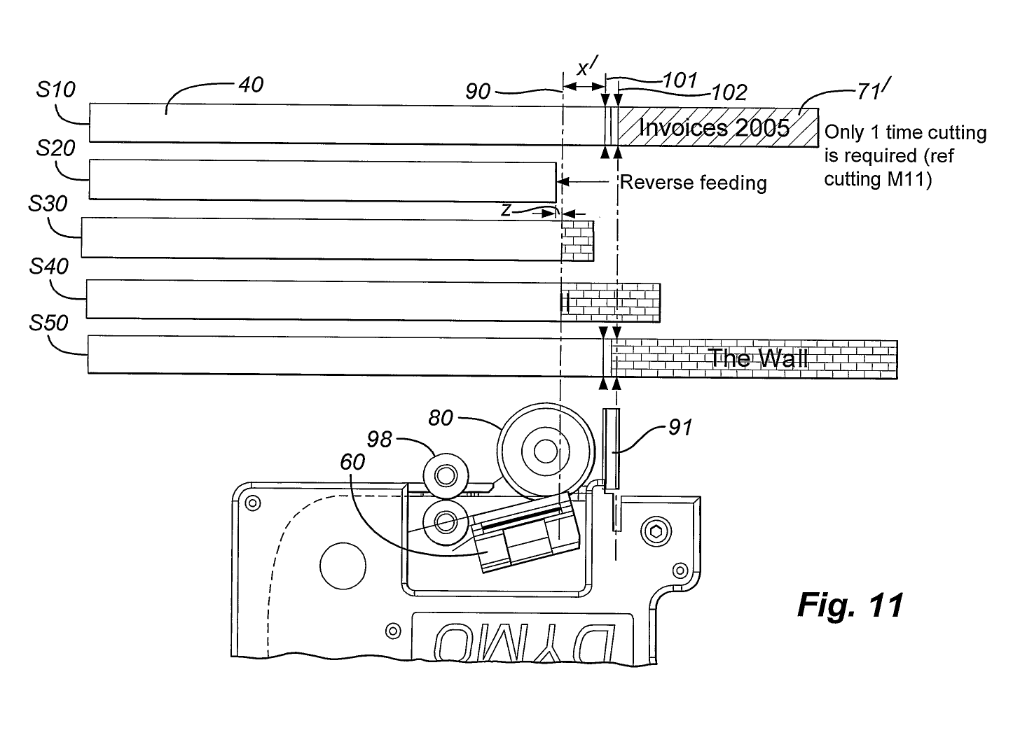

Reference is now made to FIG. 11 which shows the relative positions of the print line 90 and the cutting lines 101 and 102 with the corresponding positions of the image receiving tape 40 at various steps of printing, according to another embodiment of the present invention. In this embodiment the print line 90 is a distance x′ from the first cutting line 101. FIG. 11 also shows a modified version of the printer shown in FIG. 9. Like reference numerals are used to identify the corresponding parts of the printer.

The printer shown in FIG. 11 has a cutter 91 with two blades which operate together such that two full cuts are made simultaneously to cut out a section of tape. A pair of rollers 98 are provided upstream of the platen which are used to advance the tape. It should be appreciated that one or both of the rollers 98 may be driven. In alternative embodiments of the present invention, a single roller may be used which acts against a fixed surface provided either on the cassette or as part of the printer housing. The printer also includes a waste box (not shown).

At step (S10) the preceding label 71′ is separated from the remaining image receiving tape supply 40 by the cutter 91 performing a double cut at cutting lines 101 and 102. When the tape is cut, the tape is positioned such that the last printed line, i.e. the trailing edge of the image is positioned between cutting lines 101 and 102. The cut out section of the tape between the cutting lines is allowed to fall into the waste box positioned below the cutter.

Since it is difficult to precisely cut at the position of the last printed line of the printed image, cutting either side of the last printed line ensures that no unprinted tape exists on label 71′ once it has been cut. It also ensures that no printed image remains on the remaining tape supply 40.

At step S20, the image receiving tape is reversed. This may be achieved by driving any combination of at least one of the rollers 98, the platen 80 or the supply spool to rotate in the reverse direction using motor 207 (FIG. 4). The tape is reversed such that the leading edge of the tape is positioned a distance z upstream of the print line. The microprocessor accordingly controls the motor 207 to reverse the tape a distance x′+z.

At step S30, the tape is advanced by the pair of rollers 98. It is necessary to advance the tape using the pair of rollers 98 because when the tape is upstream of the print line there is not sufficient contact between the platen and the tape for the platen to advance the tape. The image is printed on the image receiving tape as the tape is advanced. Since the tape was reversed to a position upstream of the print line, the printed image starts at the leading edge of the tape.

At step S40 and S50, the image receiving tape 40 is advanced by the rotation of at least one of the rollers 98 and/or the platen 80 such that the last printed line of the image on the tape is driven between the cutting lines 101 and 102. The cutter 91 then makes a full cut on either side of the last printed line of the image to separate the label from the tape supply.

According to the steps set out above it is possible to print a label without blank trailers or leaders, thereby significantly improving the appearance of the label. Furthermore the number of cutting operations is limited to one at the end of printing each label. An example of labels produced in accordance with the embodiment of the invention as described in relation to FIG. 11 is shown in FIG. 10.

In an alternative embodiment of the invention as described in relation to FIG. 11, the cutter 91 may be provided with a tab cut blade to perform a tab cut through the image receiving layer only at cutting line 101 and a a full cut blade to perform a full cut at cutting line 102. In this embodiment of the invention the waste portion of the label will still be attached to the backing layer of the label when the label is ejected from the printer. Alternatively, the full cut blade is at cutting line 101 and the tab cut blade is at cutting line 102.

In still another alternative of FIG. 11, the two blades of the cutter 91 may be provided by the side planes of a rectangular blade. The rectangular blade can be constructed to either provide two full cuts or a tab cut and a full cut at cutting lines 101 and 102 respectively or vice versa.

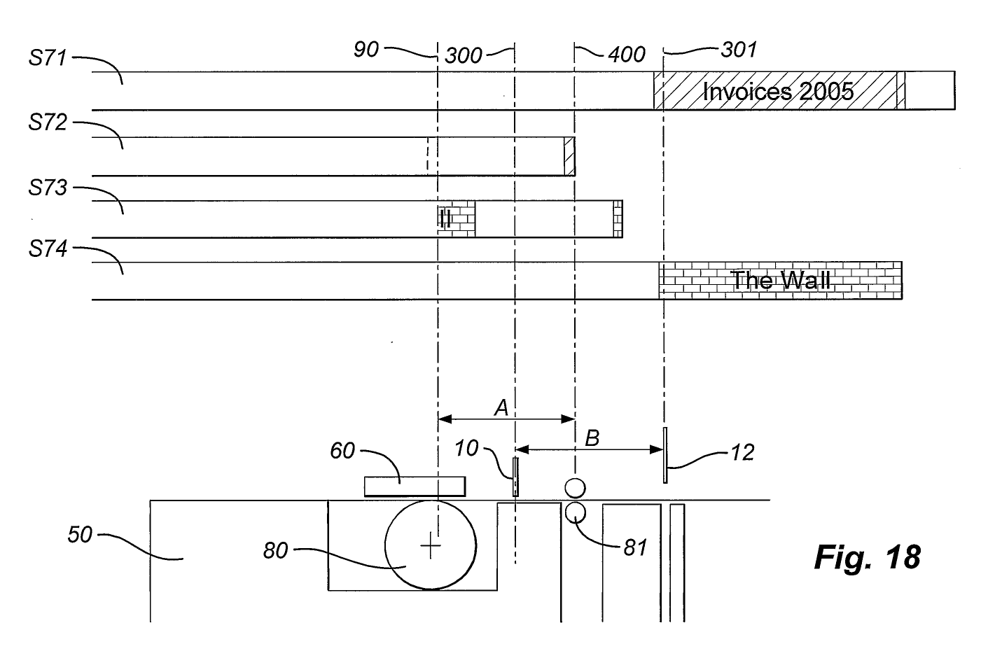

FIG. 18 shows another modified version of the printer shown in FIG. 9. Like reference numerals are used to identify the corresponding parts of the printer. As shown in FIG. 18, the platen 80 may be arranged within the recess of the cassette 50 and the print head 60 is arranged to print on the side of the tape that faces outwardly from the cassette.

In an alternative embodiment of the invention the platen may be replaced with a roller that is provided within the housing of the cassette 50. An opening in the cassette would allow the print head to contact the tape at a position corresponding to the location of the roller.

The printer shown in FIG. 18 has a cutter, downstream of the platen, having two blades 10 and 12 which operate together. Blade 10 is upstream of blade 12 and separated by a distance B. Blade 10 performs a tab cut and blade 12 performs a full cut. The tab cut and the full cut are made simultaneously. As shown in FIG. 18, tab cut blade 10 may be arranged to perform a tab cut against the cassette 50. The full cut blade 12 may be arranged to perform a full cut against a recess in the printer, close to the tape exit.

According to an embodiment of the invention a needle roller assembly 81 is provided downstream of the platen between the tab cut blade and the full cut blade 12. It is necessary to provide the needle roller assembly upstream of the full cut blade since is necessary that the needle roller is in constant contact with the tape in order to transport the tape. The needle roller assembly may be driven by the motor 207.

FIG. 18 shows the relative positions of the print line 90, the tab cutting line 300 and the full cutting line 301. FIG. 18 also shows contact line 400 illustrating the point at which the needle assembly contacts the tape.

At step S71 the first label is separated from the remaining tape supply 40 by the blade 12 performing a full cut at cutting line 301. At the same time a tab cut is made in the remaining tape supply at the cutting line 300 by tab cut blade 10. As shown, the full cut is made at a short distance downstream of the last printed line of the image printed on the first label. This ensures that there is no unprinted area on the trailing edge of the label.

At step S72 the tape is reversed such that the tab cut made by blade 10 is a short distance upstream of the print line 90. The tape may be reversed by driving at least one of the supply roll, the needle assembly or the platen in the reverse direction.

In a preferred embodiment of the invention the distance B is greater than distance A. Accordingly, when the tape is reversed in step S72 the tape is still held in the needle roller assembly 81.

In step S73 the label image is printed on the tape.

In step S74 the label is advanced by driving the needle rollers such that the last printed line of the label image is a short distance upstream of the blade cutting line 301. The label is then separated from the tape by the blade 12 performing a full cut at cutting line 301. The waste portion of length B can be removed by the user at the tab cut.

According to the steps set out above it is possible to print a label without blank trailers or leaders, thereby significantly improving the appearance of the label.

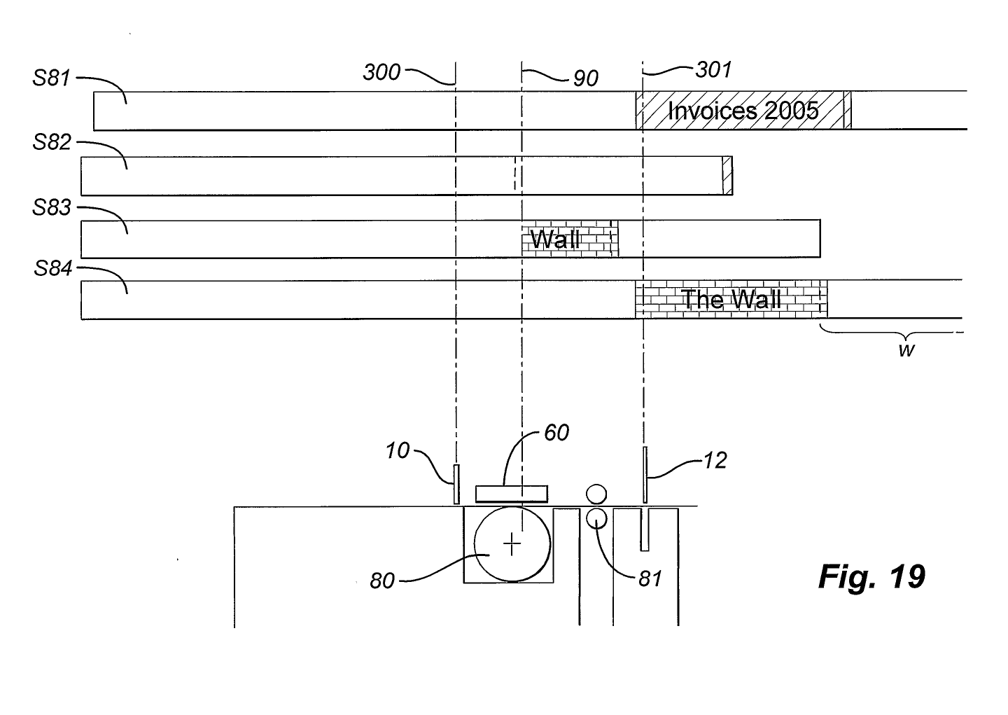

FIG. 19 shows a modified version of the printer shown in FIG. 18. Like reference numerals are used to identify the corresponding parts of the printer. As shown in FIG. 19, the tab cut blade 10 is arranged up stream of the platen 80.

A needle roller assembly 81 is provided downstream of the platen and upstream of the full cut blade 12. As previously mentioned, it is necessary to provide the needle roller assembly upstream of the full cut blade since is necessary that the needle roller is in constant contact with the tape in order to transport the tape. The needle roller assembly 81 may be driven by the motor 207.

FIG. 19 shows the relative positions of the print line 90, the tab cutting line 300′ and the full cutting line 301.

At step S81 the first label is separated from the remaining tape supply 40 by the blade 12 performing a full cut at cutting line 301. At the same time a tab cut is made in the remaining tape supply at the cutting line 300′ by tab cut blade 10. As shown, the full cut is made at a short distance downstream of the last printed line of the image printed on the first label. This ensures that there is no unprinted area on the trailing edge of the label.

At step S82 the tape is advanced such that the tab cut made by blade 10 is a short distance upstream of the print line 90. The tape may be advanced by driving at least one of the needle assembly or the platen in the forward direction.

In step S83 the label image is printed on the tape.

In step S84 the label is advanced by driving the needle rollers such that the last printed line of the label image is a short distance upstream of the cutting line 301. The label is then separated from the tape by the blade 12 performing a full cut at cutting line 301. The waste portion illustrated in the figure as ‘W’ can be removed by the user at the tab cut.

According to the steps set out above it is possible to print a label without blank trailers or leaders, thereby significantly improving the appearance of the label.

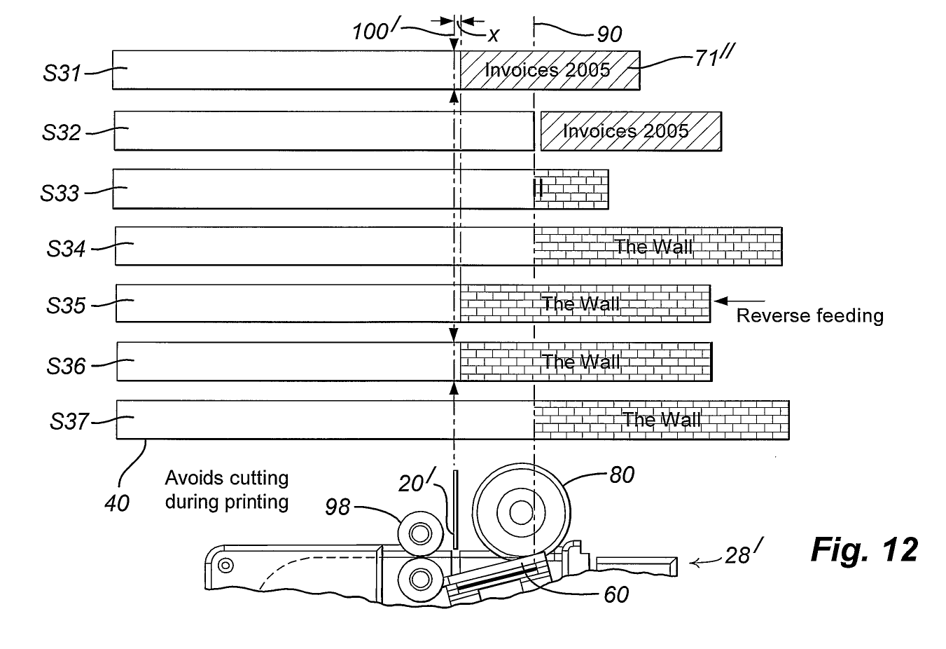

FIG. 12 shows the relative positions of the print line 90 and the cutting line 100′ of modified printer 28′ with the corresponding positions of the image receiving tape 40 at various steps of printing, according to further embodiment of the present invention. FIG. 12 also shows another modified version of the printer shown in FIG. 9. Like reference numerals are used to identify the corresponding parts of the printer.

As can be seen in FIG. 12, the printer 28′ has a cutter 20′ arranged upstream of the platen 80. Accordingly the cutting line 100′ is now upstream of the print line 90 as shown. The printer also includes a pair of rollers 98 provided upstream of the cutter.

At step S31 the first label 71″ is separated from the remaining image receiving tape supply 40 by the cutter 20′ performing a full cut at cutting line 100′. As shown, the full cut is made at a distance ‘a’ upstream of the printed image such that the label 71″ includes a blank trailer of length ‘a’.

Since it is difficult to precisely cut at the position of the last printed line of the printed image, cutting the tape upstream of the last printed line ensures that no printed tape exists on the remaining tape supply 40.

At step S32, the label 71″ is advanced out of the printer by the rotation of the platen 80. When the blank trailing edge of the label 71″ passes between the print head and the platen the printer is arranged to print the remaining image, for example the remaining colour background, on the blank trailer. Since the image receiving tape supply 40 is not in contact with the platen, the image receiving tape is advanced by the pair of rollers 98. The image receiving tape supply is advanced until the leading edge of the tape is at the print line 90.

At step S33 the image for the next label is printed on the image receiving tape as the tape is advanced. Since the tape was at a position upstream of the print line, the printed image starts at the leading edge of the tape. An end portion of length ‘a’ of the image is not printed on the label.

At step S34 the image receiving tape is reversed. This may be achieved by driving at least one of the platen 80, the supply spool or the pair of rollers 98 to rotate in the reverse direction with motor 207 (FIG. 4). The tape is reversed such that last printed line is positioned a distance ‘a’ downstream of the cutting line 100′. At this position, at step S35 the cutter 20′ performs a full cut at cutting line 100′.

At step S36, the label is advanced by the platen whilst the tape is advanced by the pair of rollers 98. At step S37, when the blank trailing edge of the label passes between the print head and the platen, the printer is arranged to print the remaining portion of the image of length a on the blank trailer. To print the complete remaining portion ‘a’, the printer will start printing when the label passes the print line at a distance ‘a+b’ from the end of the label wherein the distance ‘b’ (not shown) is a small portion of the label which will be printed twice. In a preferred embodiment of the invention the distance ‘b’ is the width of one printed line.

According to the steps set out above it is again possible to print a label without blank trailers or leaders, thereby significantly improving the appearance of the label. An example of labels produced in accordance with the embodiment of the invention as described in relation to FIG. 12 is shown in FIG. 10.

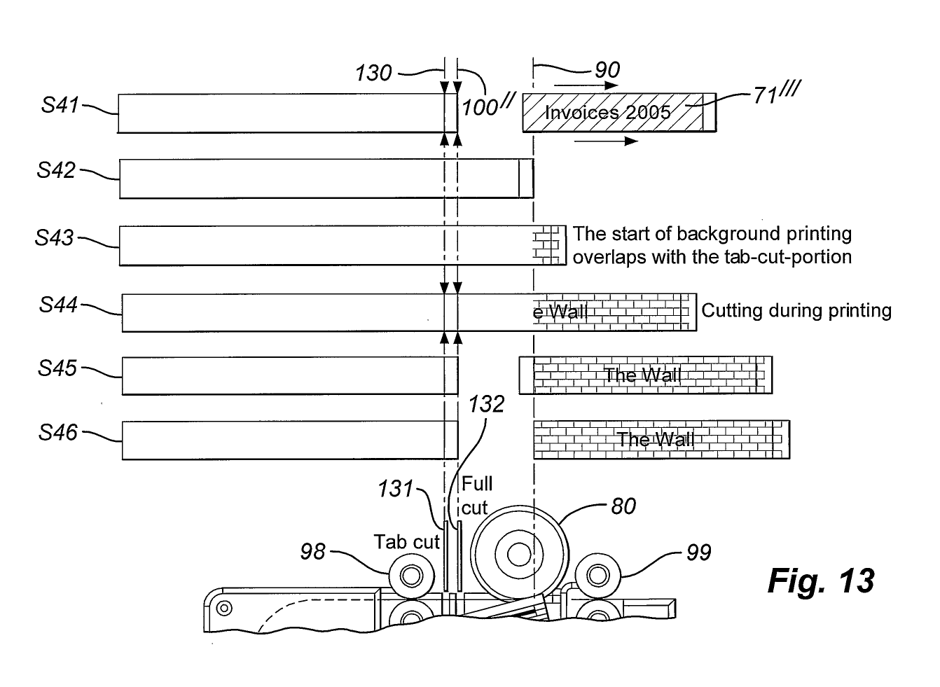

Reference is now made to FIG. 13 which shows the relative positions of the print line 90 and the cutting lines 100″ and 130 of the printer with the corresponding positions of the image receiving tape 40 at various steps of printing, according to a further embodiment of the present invention. FIG. 13 also shows another modified version of the printer shown in FIG. 9. Like reference numerals are used to identify the corresponding parts of the printer.

In a similar arrangement to the printer shown in FIG. 12 the printer has a cutter mechanism arranged upstream of the platen 80. The cutter mechanism includes a tab cut blade 131 and a full cut blade 132. In an alternative embodiment of the invention the two cutting blade may be provided by the sides of a rectangular blade. Cutting line 130 corresponds to the tab cut and cutting line 100″ corresponds to the full cut. Cutting line 130 is upstream of the cutting line 100″. The printer also includes a pair of rollers 98 provided upstream of the cutting mechanism.

In a further embodiment of the invention the printer may also include a pair of rollers 99 provided downstream of the platen. These rollers may be driven to facilitate the ejection of small labels that are similar in length to the distance between the platen 80 and the tape exit.

At step S41, the first label 71″′ is separated from the remaining image receiving tape supply 40 by the full cut blade 20′ performing a full cut at cutting line 100″. A tab cut is simultaneously made at cutting line 130 in the image receiving tape supply. The label 71″′ is printed and advanced out of the tape by the rotation of the platen and rollers 99.

At step S42 the image receiving tape supply is advanced until the print line 90 is between the leading edge of the tape and the tab cut. Since the image receiving tape supply 40 is not in contact with the platen, the image receiving tape is advanced by the pair of rollers 98.

At step S43 the image for the next label is printed on the image receiving tape as the tape is advanced. Since the print line is between the tab cut and the end of the tape at the start of printing, part of the image is printed downstream of the tab cut.

At step S44 printing is momentarily suspended and a full cut is made at a position calculated to be the end of the tape by microprocessor 200. A tab cut is made at the same time in the remaining image receiving tape supply.

At step S45 printing is resumed and the platen advances the tape. The image is printed up to the trailing end of the tape. At step 46 the printed label is advanced out of the printer. The user may then remove the label from the backing tape at the tab cut in order to obtain a label without a blank leader. An example of labels produced in accordance with the embodiment of the invention as described in relation to FIG. 13 is shown in FIG. 10.

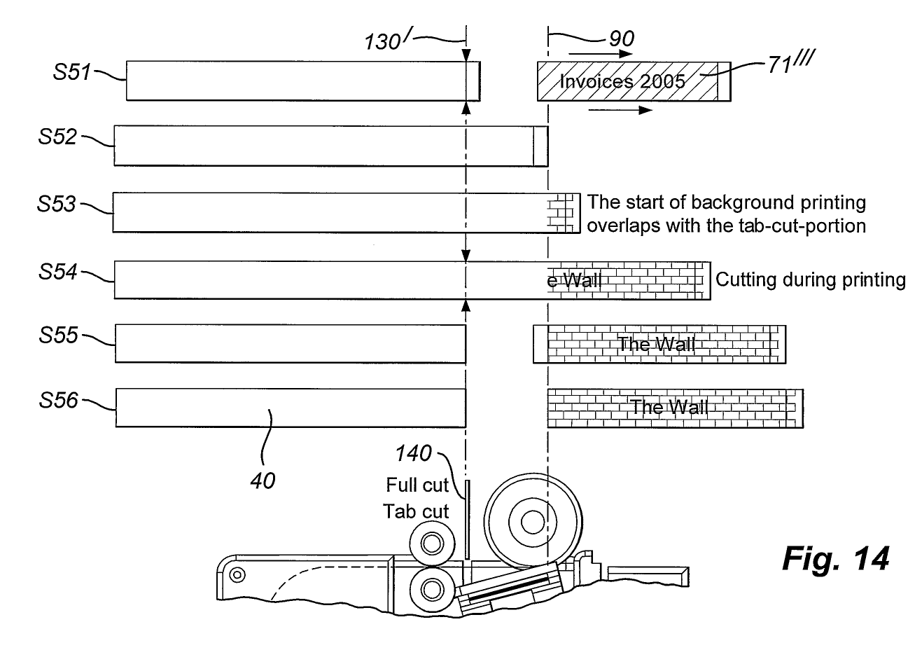

FIG. 14 shows the stages of printing with a similar arrangement to that described in relation to FIG. 13, with the exception that a single blade 140 is used to form the tab cut and full cut. Cutting line 130′ shows the location of the tab cut and the full cut.

At step S51, the first label 71″′ is separated from the remaining image receiving tape supply 40 by the cutter 140 performing a full cut at cutting line 130′. The label 71″′ is printed and advanced out of the tape by the rotation of the platen. The remaining image supply tape is then advanced by a predetermined amount and a tab cut is made by cutter 140.

At step S52 the image receiving tape supply is advanced until the print line 90 is between the leading edge of the tape and the tab cut. Since the image receiving tape supply 40 is not in contact with the platen, the image receiving tape is advanced by the pair of rollers 98.

At step S53 the image for the next label is printed on the image receiving tape as the tape is advanced. Since the print line is between the tab cut and the end of the tape at the start of printing, part of the image is printed downstream of the tab cut.

At step S54 printing is momentarily suspended and a full cut is made at a position calculated to be the end of the tape by microprocessor 200.

At step S55 printing is resumed and the platen advances the tape. The image is printed up to the trailing end of the tape.

At step 56 the printed label is advanced out of the printer. The user may then remove the label from the backing tape at the tab cut in order to obtain a label without a blank leader. An example of labels produced in accordance with the embodiment of the invention as described in relation to FIG. 14 is shown in FIG. 10.

In an alternative embodiment of the invention described in relation to FIG. 14, the cutter 140 upstream of the printing line 130′ can be used perform a full cut only. At step S52 the leading edge of the tape is brought to the printing line and printing starts at the leading edge of the tape. At steps S54, S55 and S56 the label is cut during printing and further printed after cutting in the same way as described for FIG. 14.

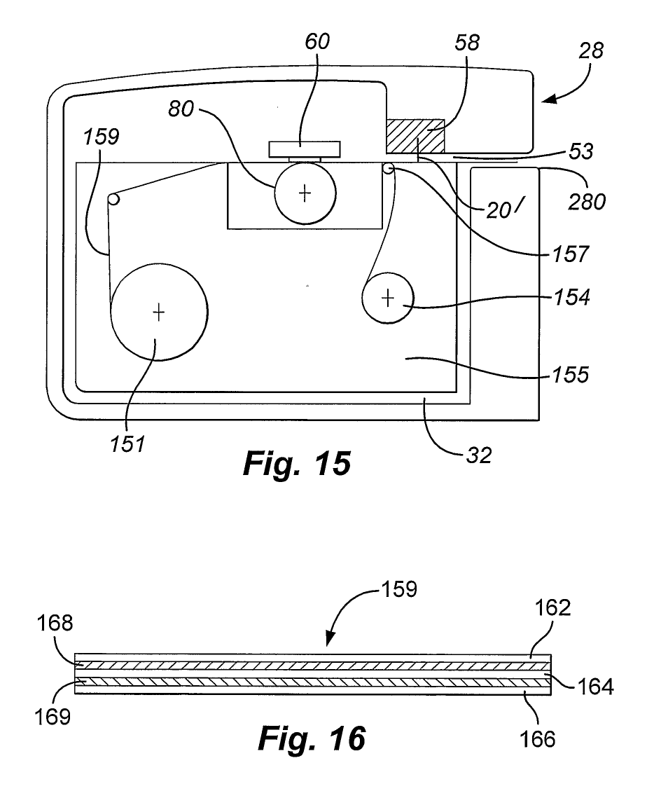

Reference is now made to FIG. 15 which shows in plan view the tape printing device 28 which has a cassette 155 arranged therein. The cassette 155 is located in the cassette bay 132. The cassette 155 contains a supply of direct thermal material liner tape 159 (described hereinafter) provided on a supply roll 151 and liner take up spool 154. According to this embodiment of the invention the platen is arranged within the recess of the cassette 155 and the print head is arranged to print on the side of the tape that faces outwardly from the cassette. In an alternative embodiment of the invention the platen may be replaced with a roller that is provided within the housing of the cassette 155.

FIG. 16 shows a schematic diagram of the direct thermal liner tape 159. The direct thermal tape comprises a first layer 162 on which an image is printed, an adhesive layer 168 which attaches a releasable backing layer 164, and a weaker adhesive layer 169 which attaches the backing layer to a liner 166.

In operation, after the direct thermal liner tape passes through the print zone the liner is drawn back into the cassette onto the liner take up spool 154. The liner tape is drawn over spindle 157 and is advanced in a direction which is at an angle in excess of 90 degrees to the direction of the tape through the print zone. The rigidity of the tape layers causes the backing layer 164 to separate from the liner 66 and for the image receiving layer and the backing layer to advance towards the cutter 20′ and out of the tape printer. Therefore when the tape 159 passes through the cutting location the tape only comprises the image receiving layer and the backing layer.

In an alternative embodiment of the present invention the tape may be cut before the liner layer is separated from the rest of the tape. In this embodiment the cutter 20′ would form a partial, or ‘tab’ cut that extends through the image receiving layer and the backing layer but not the liner layer.

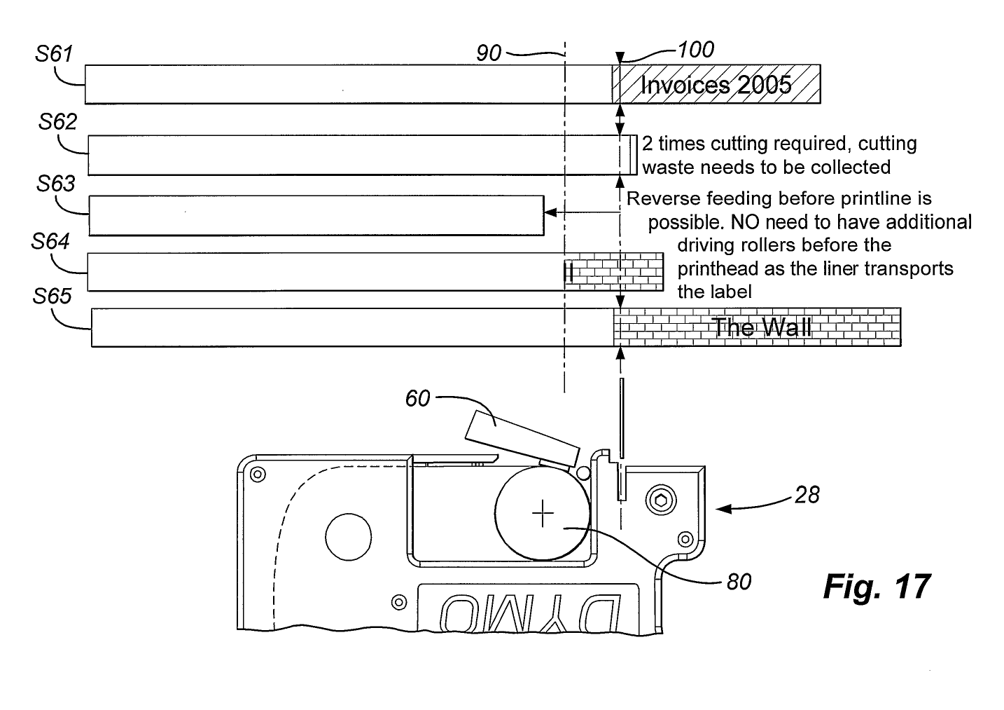

Reference is now made to FIG. 17 which shows the relative positions of the print line 90 and the cutting line 100 of printer 28 with the corresponding positions of the direct thermal liner tape 159 at various steps of printing.

At step S61 the first label is separated from the remaining image receiving tape supply 159 by the cutter 20 performing a full cut at cutting line 100. As shown, the full cut is made at a short distance downstream of the last printed line. Since it is difficult to cut precisely at the last printed line, this ensures that the image on the label extends up to the trailing edge of the label.

At step S62, the tape supply 159 is advanced a small predetermined distance and another full cut is made. This ensures that any printed image remaining from the previous label is removed. Since the section of tape which is cut off is small, it will not reach the tape exit 280 of the tape printer 28. Instead, the section of tape which is cut off is allowed to fall into a waste box (not shown) which is located below the cutting location. Alternatively, at step S62 a tab cut is made through the first layer 162 but not through the releasable backing layer 164.

At step S63, the tape is reversed such that the leading edge of the cut image receiving layer 162 is upstream of the print line 90. The tape may be reversed by driving at least one of the platen or the supply spool 151 in the reverse direction.

At step S64, the tape is advanced towards the print line by driving the liner 166 forward. The liner may be driven forward by driving at least one of the platen 80 or the liner take up spool 154. When the leading edge of the image receiving layer 162 reaches the print line 90, printing is commenced. In another embodiment of the invention printing commences shortly before the image receiving layer reaches the print line in order to ensure that the image is printed at the edge of the tape.

At step S65, when printing is completed the tape is further fed forward such that the last printed line is a short distance upstream of the cutting line 100. A full cut is then made, separating the label from the tape supply 159.

According to the above embodiment of the present invention, described in relation to FIG. 17, it is possible to produce labels that do not have blank leaders or trailers without the need for separate means for driving the tape when the image receiving tape is upstream of the print head.

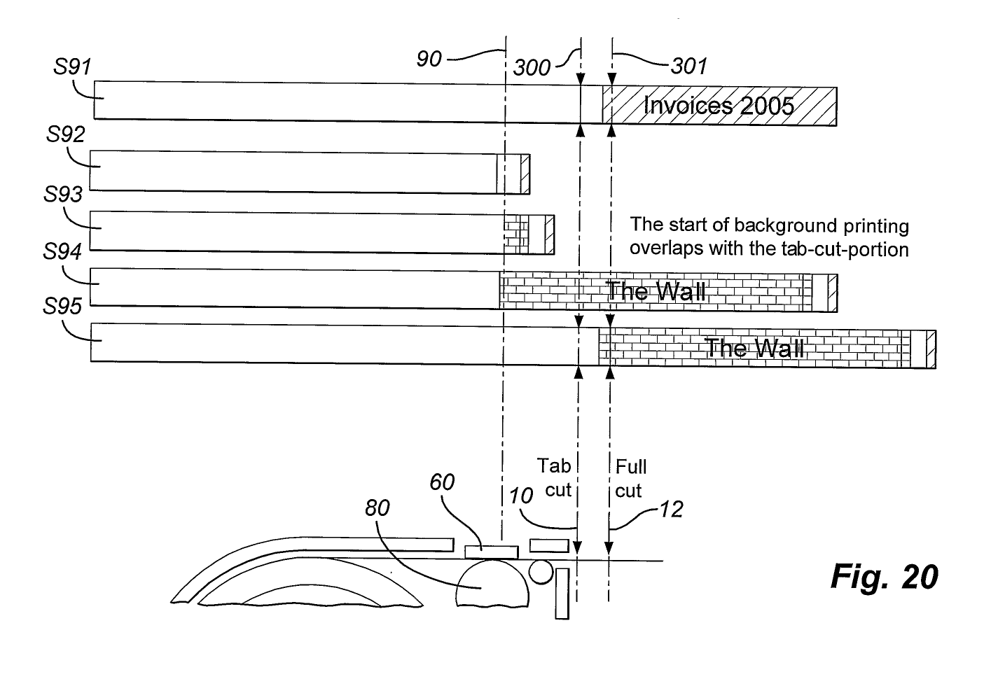

FIG. 20 shows a modified version of the printer shown in FIG. 17. Like reference numerals are used to identify the corresponding parts of the printer. As shown in FIG. 20 the printer in this embodiment comprises a tab cut blade 10 and a separate full cut blade 12. The relative positions of the cutting lines for the tab cut blade and the full cut blade are indicated by lines 300 and 301 respectively. The printing position is indicated by print line 90.

At step S91 the first label is separated from the remaining image receiving tape supply 159 by the blade 12 performing a full cut at cutting line 301. At the same time the tab cut blade performs a tab cut in the remaining image receiving tape supply at cutting line 300. As shown, the full cut is made at a short distance downstream of the last printed line. Since it is difficult to cut precisely at the last printed line, this ensures that the image on the label extends up to the trailing edge of the label.

At step S92, the tape is reversed such that the tab cut in the image receiving layer 162 is upstream of the print line 90. The tape may be reversed by driving at least one of the platen or the supply spool 151 in the reverse direction.

At step S93, the tape is advanced by driving the liner 166 forward and printing commences. The liner may be driven forward by driving at least one of the platen 80 or the liner take up spool 154.

At step S94 the label is printed.

At step S95, when printing is completed the tape is further fed forward such that the last printed line is a short distance upstream of the cutting line 301. A full cut is then made, separating the label from the tape supply 159.

It should be appreciated that embodiments of the invention are applicable to continuous tape and also, where appropriate die cut labels arranged on a continuous backing layer.

1-53. (canceled)

54. A method of printing an image on an image receiving tape comprising:
advancing the tape in a first direction such that a predetermined portion of the tape is downstream of the printing location,
printing an image while advancing the tape in a second direction
suspending printing and then cutting the tape when at least the predetermined portion of tape is downstream of the cutting location,
resuming printing while advancing the tape in a second direction, and
cutting the tape again when the end of the image is a predetermined distance upstream of the cutting location.

55. A method of printing an image on an image receiving tape comprising;
cutting the image receiving tape simultaneously at a first and second cutting location to remove a previous label, when a last printed line of the previous label is at a position between the first and second cutting locations;
advancing the image receiving tape in a first direction such that the position of the first cut on the image receiving tape is a predetermined distance upstream of a printing location,
printing the image,
advancing the image receiving tape in a second direction to a position where the end of the image is between the first and second cutting locations, and
cutting the image receiving tape at said second cutting location to form a label.

56. A method according to claim 55 wherein the image receiving tape is advanced by advancing a liner attached to the image receiving tape.

57. A method as claimed in claim 55 wherein the printing location is located between the first and second cutting locations.

58. A method of printing an image on an image receiving tape comprising;
advancing the tape in a first direction such that the end of the tape is aligned with a printhead at a printing location,
printing the image,
advancing the tape in a second direction to a position where the end of the image is a predetermined position from a cutting location, and
cutting the tape to form a label.

59. A method according to claim 58 wherein when the tape is advanced to a position where the end of the image is a predetermined position from the cutting location, the end of the image is upstream of the cutting location.

60. A method according to claim 58 wherein when the tape is advanced to a position where the end of the image is a predetermined position from the cutting location, the end of the image is downstream of the cutting location.

61. A method as claimed in claim 60, further comprising the step of printing a remaining image downstream of end of the image on the label.

62. A method of printing an image on an image receiving tape comprising:
advancing the tape in a first direction such that the end of the tape is at a printing location,
printing a first part of the image while advancing the tape in the first direction,
suspending printing and then cutting a full cut through the tape when the end of the label is at a first cutting location,
resuming printing a second part of the image, which second part of the image is upstream and adjacent on the tape to the first part of the image, while advancing the label in the first direction.

63. A method as claimed in claim 62 wherein the cutting location is provided upstream of the printing location.

64. A method as claimed in claim 62 wherein the step of cutting comprises a simultaneous tab cut and full cut.

65. A method of printing an image on an image receiving tape comprising
advancing the tape in a first direction such that the end of the image receiving tape is a predetermined distance upstream of the printing location;
printing on the tape while advancing the tape in a second direction;
advancing the tape in the second direction after said printing to a position where the end of the image is a predetermined position upstream of a cutting location; and
cutting a full cut through the image receiving tape at the cutting location to form a label.

66. A method according to claim 65 wherein the image receiving tape is advanced by advancing a liner attached to the image receiving tape.

67. A method as claimed in claim 54 wherein the image printed on the image receiving tape includes a background image.

68. A tape printer comprising;
a cassette receiving portion for receiving a cassette,
a print head comprising a plurality of printing elements for printing an image on a tape,
a driver for driving a tape passed the print head,
a cutter arranged to cut the tape at a cutting location; and
a controller for controlling the driver to advance the tape in a first direction such that a predetermined portion of the tape is downstream of a printing location, to advance the tape in a second direction during printing until printing is suspended, and to advance the tape in the second direction when printing is resumed, and for controlling the cutter to cut the tape when at least the predetermined portion of tape is downstream of the cutting location while the printing is suspended, and wherein the controller is arranged to control the cutter to cut the tape again when the end of the image is a predetermined distance upstream of the cutting location.

69. A tape printer comprising;
a cassette receiving portion for receiving a cassette,
a print head comprising a plurality of printing elements for printing an image on an image receiving tape,
a driver for driving the image receiving tape passed the print head,
a controller for controlling:
a cutting apparatus to for cutting the tape simultaneously at a first and second cutting location to remove a previous label, when a last printed line of the previous label is at a position between the first and second cutting locations;
the driver to advance the tape in a first direction such that the position of the first cut on the image receiving tape is a predetermined distance upstream of a printing location before printing, and to advance the tape in a second direction to a position where the end of the printed image is between the first and second cutting location; and
further controlling the cutting apparatus to cut the tape at the second cutting location to form a label.

70. A tape printer as claimed in claim 69 wherein the controller is for controlling the cutting apparatus to cut the tape at the first and second cutting locations simultaneously to form the label.

71. A tape printer as claimed in claim 69 wherein the printing location is located between the first and second cutting locations.

72. A tape printer as claimed in claim 69 wherein the driver is arranged to drive the image receiving tape by driving a liner attached to the image receiving tape.

73. A tape printer comprising;
a cassette receiving portion for receiving a cassette,
a print head at a printing location, the print head comprising a plurality of printing elements for printing an image on a tape,
a driver for driving a tape passed the print head,
a controller for controlling the driver to advance the tape in a first direction such that the end of the tape is aligned with the print head at the printing location before printing, and to advance the tape in a second direction to a position where the end of the printed image is a predetermined position from a cutting location; and
a cutter arranged to cut the tape at the cutting location to form a label.

74. A tape printer according to claim 73 wherein when the tape is advanced to a position where the end of the image is a predetermined position from the cutting location, the end of the image is downstream of the cutting location.

75. A tape printer according to claim 74 wherein the controller is further arranged to control the print head to print a remaining image downstream of end of the image on the label after the cutter has cut the tape.

76. A tape printer comprising;
a cassette receiving portion for receiving a cassette,
a print head comprising a plurality of printing elements for printing an image on a tape,
a driver for driving a tape passed the print head,
a controller for controlling the driver to advance the tape in a first direction before printing, to a position where the end of the tape is located at a printing location, to advance the tape in the first direction during printing until printing is suspended, and to advance the tape in the first direction when printing is resumed; and
a cutter arranged to cut a full cut in the tape at a first cutting location while the printing is suspended and while the end of the label is at the first cutting location.

77. A tape printer according to claim 76, wherein the first cutting location is provided upstream of the printing location.

78. A tape printer comprising;
a cassette receiving portion for receiving a cassette,
a print head comprising a plurality of printing elements for printing an image on a tape,
a driver for driving a tape passed the print head,
a controller for controlling the driver to advance the tape in a first direction such that the end of the tape is a predetermined distance upstream of a printing location before printing before printing, to advance the tape in a second direction during printing, and to advance the tape in the second direction after said printing to a position where the end of the image is a predetermined position upstream of a cutting location; and
a cutter arranged to cut a full cut through the tape at the cutting location to form a label.

79. A tape printer as claimed in claim 78 wherein the driver is provided by driving a liner attached to the image receiving tape.

80. A tape printer comprising;
a cassette receiving portion for receiving a cassette,
a print head at a printing location, the print head comprising a plurality of printing elements for printing an image on a tape,
a driver for driving a tape passed the print head,
a controller for controlling the driver to advance the tape in a first direction such that the end of the tape is at a predetermined position downstream of the printhead at the printing location, such that a first length of the tape is located between the end of the tape and the printing location, to feed the tape in a second direction during printing, and to advance the tape in the second direction to a position where the end of the printed image is a predetermined position downstream from a cutting location, such that a second length of tape is located between the end of the image and the cutting location; and
a cutter arranged to cut a full cut through the tape at the cutting location to form a label including the first and second lengths of tape.

81. A tape printer according to claim 27 wherein the length of one or both of the first and second lengths of tape is less than the distance between the printing location and the cutting location.

82. A method of printing an image on an image receiving tape comprising;
advancing the tape in a first direction such that the end of the tape is at a predetermined position downstream of a printhead located at a printing location, such that a first length of the tape is located between the end of the tape and the printing location,
printing the image while feeding the tape in a second direction,
advancing the tape in the second direction to a position where the end of the image is at a predetermined position downstream from a cutting location, such that a second length of tape is located between the end of the image and the cutting location, and
cutting a full cut through the tape at the cutting location to form a label including the first and second lengths of tape.

83. A method according to claim 82 wherein the length of one or both of the first and second lengths of tape is less than the distance between the printing location and the cutting location.
